(19) United States
(12) Patent Application Publication
(10) Pub. No.: US 2009/0266854 A1
(43) Pub. Date: Oct. 29, 2009

(54) Golf Bag Securing Device and Method for Same

(76) Inventor: Greg Schmidt, Cottonwood Heights, UT (US)

Correspondence Address: KIRTON AND MCCONKIE, 60 EAST SOUTH TEMPLE,, SUITE 1800, SALT LAKE CITY, UT, 84111, US

(21) Appl. No.: 12/391,194

(22) Filed: Feb. 23, 2009

Related U.S. Application Data
(60) Provisional application No. 61/030,854, filed on Feb. 22, 2008.

(51) Int. Cl. B60R 9/00

(52) U.S. Cl. 224/274; 224/534; 224/5

(57) ABSTRACT

A method and apparatus for selectively securing a golf bag to a golf cart to prevent the golf bag from pivoting or rotating while being transported by the cart. A coupling member which may be a strap, a rigid body, or a clamp that may selectively tightened, may be coupled to a golf bag structure. The coupling member may be used to selectively couple a golf bag and a cart together to prevent the golf bag from rotating on the back of the cart, thus improving the golfer's access to the bag's exterior pockets and other accessories. A toggle may also be used to further selectively secure a golf bag to a cart.

### RELATED APPLICATIONS

This application claims priority to U.S. Provisional Application Ser. No. 61/030,854, filed Feb. 22, 2008.

### BACKGROUND OF THE INVENTION

Golf bags are designed for specific game styles; a major distinction in golf bags is cart bags verses walking bags. For example, cart bags tend to weigh more and have a larger volume. In contrast, walking bags often have a harness system to aid the golfer or caddy in carrying the bag through a typical golf game. Furthermore, many golf bags incorporate retractable support legs that extend to keep the bag upright when the bag is not being carried. Features such as the retractable legs often involve placing an apparatus on the bottom of the bag displaced a distance beyond the bottom of the bag itself, which when the weight of the bag is placed thereon adjusts and forces the legs out. In contrast, bags specifically designed for cart use generally have flat bottoms designed to sit on the back of a cart without moving. Despite a walking bag's specific features, golfers regularly use walking bags when riding a cart.

Golf carts generally provide a space in which to place and secure golf bags for transport while golfing. This space generally consists of a platform which supports the weight of the bag. In addition, a cart generally provides a wrap which can be placed around the circumference of the golf bag. However, in order to accommodate the wide variety of golf bags golfers use, the golf cart support space is generally much larger than most bags and the wrap is generally too loose to adequately secure either cart or walking golf bag in a single position.

Furthermore, as a result of these different golf bag designs, walking bags used as cart bags often move and shift while secured to the back of the cart. These unintentional shifts reduce the bags utility by allowing the bag to rotate while sitting in the back of a cart, thus disposing pockets, towels and other bag features between the cart and the bag and generally away from the user's reach.

Moreover, the traditional method of wrapping the cart wrap around the entire golf bag further restricts and limits access to pockets, towels, and other features found on the outside of the bag.

### SUMMARY

Exemplary embodiments of the invention are a coupling member to selectively couple a golf bag to a golf cart. The coupling member secures both the bag to the cart and prevents the bag from rotating as it is transported on a cart. An exemplary embodiment of such a coupling member is a selectively securable strap which binds to the legs of the bag and secures the legs to a golf cart. An alternative embodiment of the invention is a rigid coupling body which can be placed on a golf bag's retractable legs and then secured to a golf cart.

### BRIEF DESCRIPTION OF THE DRAWINGS

FIG. 1 illustrates an exemplary embodiment of a coupling member comprising a selectively securable strap.

FIG. 2A illustrates an alternative exemplary embodiment of the invention.

FIG. 2B illustrates an alternative embodiment of a coupling member comprising a rigid coupling member.

FIG. 2C illustrates a profile view of a rigid coupling member of FIG. 2B.

FIG. 2D illustrates a profile view of an alternative exemplary embodiment of a strap.

FIG. 3A illustrates an alternative exemplary embodiment of a securing system.

FIG. 3B illustrates an alternative view of the securing system of FIG. 3A.

FIG. 4A illustrates an alternative view of the rigid coupling member.

FIG. 4B illustrates an alternative view of the rigid coupling member of FIG. 4A.

FIG. 5 illustrates an alternative embodiment of securing the coupling mechanism.

FIGS. 6A-6D illustrate alternative tightening mechanisms.

FIG. 7 illustrates an exemplary utilization of a coupling member.

FIG. 8 illustrates an alternate view of the exemplary utilization coupling member.

### DETAILED DESCRIPTION OF EXEMPLARY EMBODIMENTS

This specification describes exemplary embodiments and applications of the invention. The invention, however, is not limited to these exemplary embodiments and applications or to the manner in which the exemplary embodiments and applications operate or are described herein. Moreover, the Figures may show simplified or partial views, and the dimensions of elements in the Figures may be exaggerated or otherwise not in proportion for clarity. In addition, as the terms “on” and “attached to” are used herein, one object (e.g., a material, a layer, a substrate, etc.) can be “on” or “attached to” another object regardless of whether the one object is directly on or attached to the other object or there are one or more intervening objects between the one object and the other object. Also, directions (e.g., above, below, top, bottom, side, “x,” “y,” “z,” etc.), if provided, are relative and provided solely by way of example and for ease of illustration and discussion and not by way of limitation.

As used herein, selectively comprises releaseably coupleable such that a user may couple the member and uncouple the member as desired.

Securing system means a strap with a means to secure the strap in a loop and means to secure the strap to another member.

An exemplary embodiment of the coupling member which may comprise a selective securable strap (hereinafter “strap”) or a rigid coupler selectively secures a golf bag to a golf cart so as to prevent the golf bag from rotating when placed on the back of a cart. Accordingly, the coupling member promotes easy access to auxiliary pockets and other utilities commonly found on the exterior or interior of golf bags. When the securing system is utilized, the strap is selectively coupled to a member of a golf bag such as support legs by securing a first member to the legs and securing the strap and then selectively coupling a second member of the strap to a golf cart structure. The members are releaseably secured using Velcro, ties, buttons, snaps, or other appropriate securing means. The strap effectively selectively couples the bag to the cart to maintain the position of the bag to the cart and prevent the bag from rotating on the cart. Multiple straps may be used to initiate multiple points of contact thus increasing the security and strength of the straps' coupling.

An alternative exemplary embodiment of the coupling member is a rigid body having a groove formed therein to receive a portion of a golf bag such as a retractable leg. The rigid body coupling member is then secured to a strap which is wrapped around a portion of the golf cart.

An alternative exemplary embodiment of the coupling member is a rigid body having a clamp which can be selectively tightened by a screw or other tightening means when it is secured to a portion of the golf bag. The rigid body has a clamp to receive a portion of the golf bag, such as a retractable leg, and the clamp can be tightened and secured to the golf bag. The coupling member is then coupled to a portion of the golf cart via a strap or some other securing means.

Alternatively, a coupling member may be secured to the golf bag's exterior. In such an alternative embodiment, a clip, buckle, strap, receiver or other securing means may be sewn or releaseably coupled to a structure or the bag's exterior. The coupling member is then secured to a portion of the golf cart. In addition, a variety of coupling means or mechanisms may be employed to secure the device in a particular orientation.

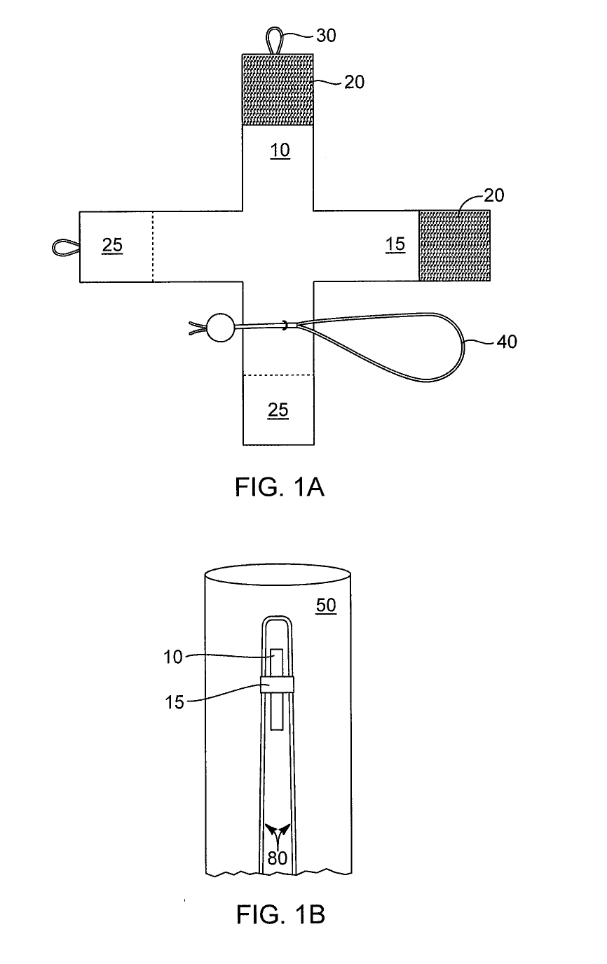

FIG. 1A illustrates an exemplary embodiment of a strap 5 comprising a fist member 10 and a second member 15. A selectively releasable fastener 20 is fixed to the end of two of the ends of the member 10 and member 15. The selectively releasable fastener 20 may be a hook and loop Velcro patch, a snap, a button, a tie, a magnet or any other fastener commonly known in the art. The strap 5 functions to retain the position of a golf bag in relation to the cart by wrapping members 10 around a golf cart structure such as a cross bar, a support bar, a basket, or other suitable golf cart structure while at the same time wrapping members 15 around a feature on a golf bag, such as support legs to selectively fix the bag's leg's in relation to the golf cart structure. The fasteners 20 and 25 provide for selectively coupling the members around the legs or golf cart structure. The strap may be coupled to a golf cart structure having a vertical, horizontal or other orientation. The strap 5 may comprise multiple first members 10 or second members 15 to improve the robustness of the strap 5. Furthermore the first member 10 and second member 15 may comprise a variety of lengths including sufficient to wrap around a golf cart member adjacent to the bag, or of sufficient length to couple the strap 5 to a golf cart structure some distance from the golf bag, for instance to the golf cart seat or other similar structure. Since the strap 5 is commonly used in conjunction with a more robust securing mechanism the fastener 20 may be of lighter construction and capable of supporting relatively light loads compared to the weight of the golf bag. However, a more robust embodiment of the strap, complete with fasteners capable of securing loads equal to or greater than the load of a golf bag is disclosed as well.

A mating fastener 25 is further disclosed. The member 10 is folded over so that fastener 20 is mated to mating fastener 25 also located on member 10. Similarly the faster 20 and mating fastener 25 on member 15 are selectively mated. When the fastener 20 and mating fastener 25 for the respective members are coupled, the strap forms two contiguous loops in orthogonal orientations. However, where multiple securing members 10 are used, such members are coplanar, while the securing member 15 is orthogonal members 10.

Also disclosed is grab loop 30 positioned on each member which aids the user in coupling and decoupling the strap members.

Further illustrated is an optional toggle 40 which secures the strap 5 and a golf bag coupled thereto, to a golf cart frame or any part of the golf cart including a basket, a water bottle holder or other cart structure or feature. The toggle secures the strap 5 to the cart structure by wrapping the toggle's loop around a cart structure and placing the loop over the ball located on the opposite end of the toggle. The toggle 40 further secures a golf bag in a desired position. The toggle 40 comprises an elastic cord, ties, or other securing mechanisms commonly known in the art. Alternatively the toggle 40 may comprise a static cord, and the ball may comprise a pinch stopper which allows the length of cord to be selectively adjusted and secured at a desired length, thus allowing the user to select the desired position. The toggle serves to provide an additional anchor point to prevent the golf bag from moving or sliding once secured to the cart. The toggle 40 may couple to the cart on the same structure as the strap 5 or to an alternate golf cart structure. When a strap is anchored by the toggle 40 the strap is prevented from sliding along the length of the golf cart structure to which the strap 5 it is coupled. This, in turn, prevents the golf bag, secured by the strap 5, from shifting during transport on a cart.

Member 10 or member 15 further comprises multiple straps or alternatively multiple with multiple widths. Additional straps or increased surface area of each member supports a greater load applied to the strap 5 and increases the security of the anchor. In addition, a second member could straddle features commonly found on a cart, such as a vertical bar, and thus further secure the bag 35 in position. The increased surface area further provides a greater area upon which to place indicia such as a sponsor's logo. Alternatively, a single member of greater width can be used to provide the desired increased bag security.

In addition, the strap 5 may further comprise an advertising patch or patch 42 whereon an advertiser may place a logo, brand or other desirable indicia. The logo is positioned to be featured prominently on the strap when coupled to a cart.

FIG. 1B illustrates the strap 5 coupled to a golf bag 50 with the strap 15 wrapped around the golf bag's support legs 80 and the strap 10 extended in preparation for wrapping around a portion of a golf cart.

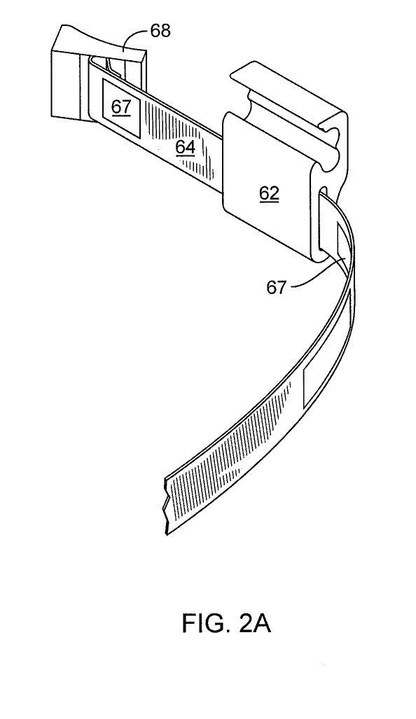

FIG. 2A illustrates an alternative exemplary embodiment of coupling member 62 comprising a strap 64 having a buckle 68 secured to one end of the of the strap 64, the other end of the strap 64 left free to enable a user to wrap the strap 64 around a structure to which the user wishes to secure a golf bag such as a golf cart. The strap 64 is laced through a slot in the coupling member 62 to secure the strap 64 to coupling member 62. To secure the strap 64, the free end is laced through the buckle 68 and secured in place, thus creating a loop.

In certain alternative exemplary embodiments the coupling member 62 can either be secured in a fixed position to the strap 64, or alternately, the strap 64 can be left to freely pass through the coupling member 62 to allow the user to reposition the coupling member 62 in relation to the strap 64 as desired.

In alternative exemplary embodiments, a slip resistant surface, such as a rubber patch, is secured to strap 64. The slip resistant material 67 is secured to strap 64 to improve the security hold of the strap to the member to which the strap is secured, such as a golf cart. By utilizing a slip-resistant surface, the user can ensure the position of the strap 64 in relation to the coupling member 62, and the position of the strap 64 in relation to the body to which the strap is secured, such as a golf cart. If the strap has an advertising logo placed thereon then the slip resistant surface will ensure the logo is not accidentally covered up.

In addition, the slip resistant surface 67 allows the strap 64 to properly hold the golf bag in the desired position. For example, if the strap 64 is used to secure a golf bag to a golf cart then, the movement of the cart may cause the bag to reposition in a way which is not conducive to accessing the golf bag's pockets. However, by using non-slip or slip resistant material 67, the strap 64 and the bag secured thereby, will be less likely to slip.

The non-slip material can be placed anywhere on the strap 64 and can be divided into small sections or can be a single congruous section of non-slip material 67. For example, the slip resistant patch may be positioned on the strap where the strap needs to be sewn for example, where the strap 64 is secured to the buckle 68, or on the back side of a logo which may be sewn to the strap 64. In addition the non-slip material 67 can be placed releaseably on the strap 64 to allow the user to reposition the non-slip material as desired. The non-slip material 67 can be made to be releaseably coupleable by using hook and loop material on one side of the strap as is commonly known in the art.

FIGS. 2B-2D illustrate alternative exemplary embodiments of coupling member comprising a rigid body 62 gripping a golf bag's leg 80. The rigid coupling member 62 is formed from a rigid material such as metal, metal alloy, ceramic, composite or polymer such as polyethylene or other suitable material. The rigid coupling member 62 is formed using extrusion, molding, machining or other techniques.

In utilizing the rigid coupling member 62 the user places the golf bag leg 80 between the body and the flange of the member 62. The space between the body and flange is spaced so as to be slightly narrower than a standard width of a leg 80 so that a force is required to separate the body and flange and allow the leg to seat in the hollow of the member 62. However, alternative embodiments teach a coupling member with a variety of gaps to accommodate different sized legs is also disclosed. As a result, a compression force is exerted on the leg 80 to keep the coupling member 62 in a secure position. Inasmuch as leg widths vary from bag to bag, the member 62 may be manufactured in a variety of sizes.

Strap 64 is then passed through loop 63 formed in the body of the member 62 and secured using a securing mechanism. The strap is then placed over a portion of a golf cart and tightened to retain the golf bag in a fixed position in relation to the golf cart. A position for an indicia such as a logo or other advertising is provided and is positioned by the user to display the logo while the coupling member is in use. A patch for displaying the logo may be releaseably coupled to the strap using hook and loop or a clear cover under which a logo may be placed.

Alternative exemplary embodiments also teach a strap 64 comprising a loop through which the free end of the strap 64 may pass through as shown in FIG. 2C. The free end of the strap 64 is then doubled back on the strap 64 and secured to strap 64 using a clip, buckle or hook and loop securing system.

Furthermore, one or more members 62 can be used to secure the bag to the cart, depending on the user's needs.

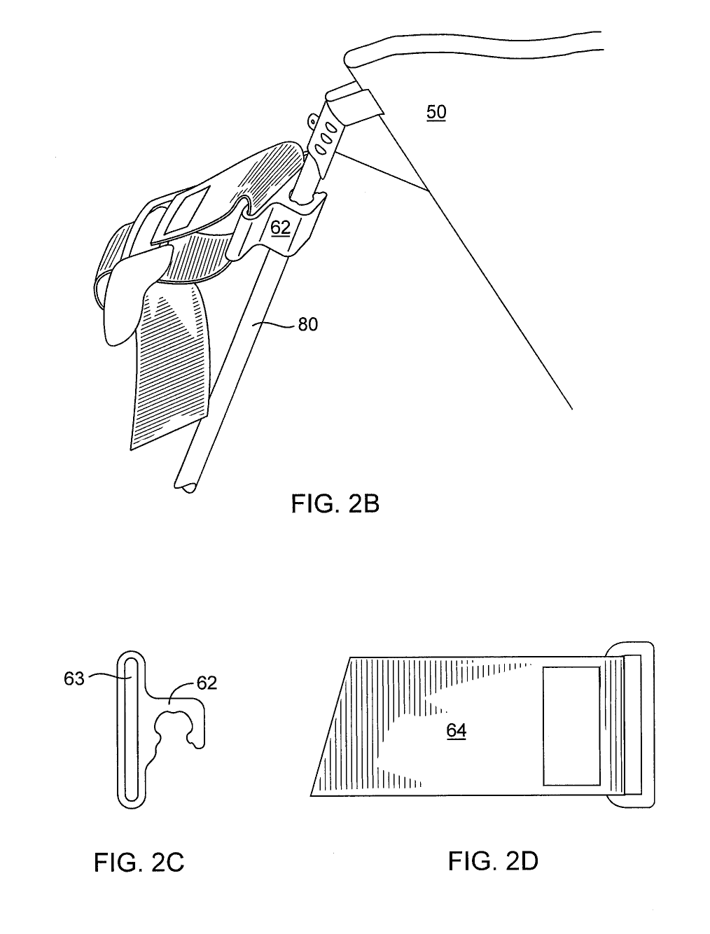

FIGS. 3A and 3B illustrate an alternative exemplary embodiment of a selectively securable mechanism 43 comprising a strap 50, coupling leg stand couplers 60 and securing straps 45. Generally, strap 50 is a rigid or semi-rigid member made of plastic, composite, wood, metal, ceramic, fiber or other appropriate material, which supports the leg stand couplers 60. The leg stand coupler 60 further comprises leg wraps 55 which are selectively coupleable to golf bag leg stands 80 and are selectively tightened into place via a screw nut 65 which can clamp the leg stand couplers 60 to the golf bag leg stands 80. The strap 50 interfaces the leg stand coupler 60 with at least one wrap 45 which positioned perpendicular to the strap 50 and is selectively coupleable to a golf cart member such as a cross bar commonly found on golf carts.

A method of employing the selectively securable mechanism 43 is as follows: providing a strap 50 having engages the leg stand couplers 60 and straps 45; coupling leg stand couplers 60 to a golf bag support legs 80 via leg wraps 55; tightening the leg wraps 55; positioning the strap 50 adjacent a golf cart structure such as a cross bar or other sufficiently strong golf cart structure; wrapping the wraps 45 around the selected golf cart structure using Velcro, snaps, buttons, ties or other selective securing means commonly known in the art.

An alternative exemplary embodiment provides strap 50 may be selectively removed from leg stand couplers 60 by sliding the strap 50 through loops 70. However in such an embodiment, wraps 45 would not pass through strap 50, but would selectively couple to the strap 50 by some other releaseably coupleable means such as Velcro, or other means known in the art. The strap may be selectively placed or removed in the loops 70 as the user desires. Thus when the user places the golf bag on a cart, the strap 50 may be used as desired. When not in use the strap 50 may be placed in a pocket on the golf bag.

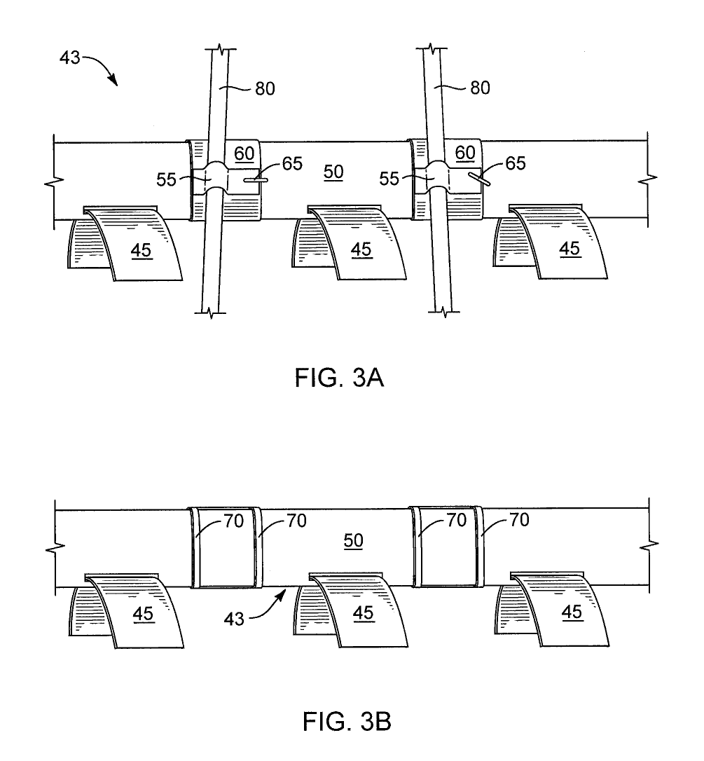

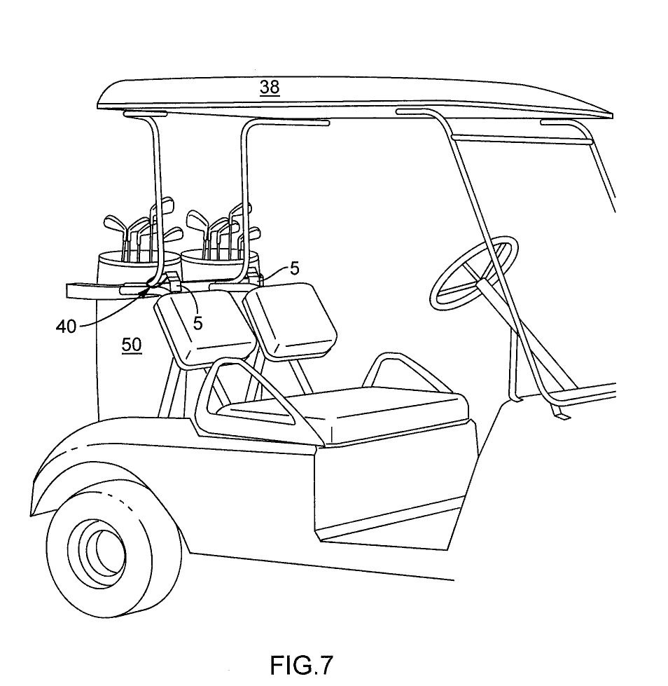

FIGS. 4A and 4B illustrate the leg stand couplers 60 from FIG. 7 wherein the leg stand couplers 60 comprise a plurality of loops 85. Screw nut 65 is selectively coupleable and can be tightened to reduce the space formed by leg wraps 55 to secure the leg wrap. Also illustrated in 4B is leg stand coupler 60 can be rotated as desired. A golf bag leg stand 80 is inserted through the space formed between the leg stand coupler 60 leg wrap 55 and positioned appropriately, the screw nut 65 is then tightened and to secure the leg stand coupler 60 into the desired position.

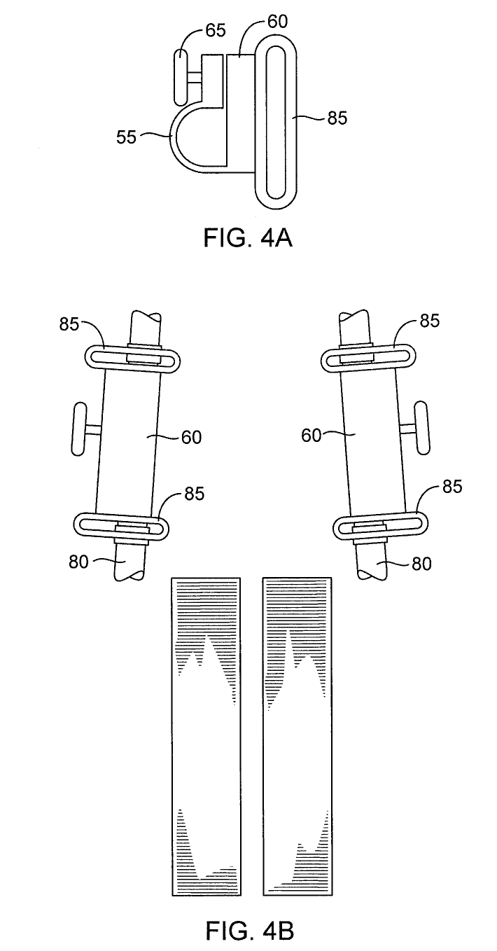

FIG. 5 illustrates an alternative exemplary embodiment of the selectively securable mechanism 75 comprising leg stand couplers (not shown) having loops 85 which straddle a golf cart member 90. The exemplary embodiment 75 teaches a releaseably coupleable securing device which can be continually fixed to the golf bag support legs and secured to a golf cart structure as desired. Specifically, leg wraps further comprise loops 85 positioned on opposite sides of the leg wraps so as to straddle the golf cart structure. A wrap 45 is then placed through the loops 85 and around the golf cart member 90 so as to secure the leg stand coupler (not shown) to the golf cart member. Alternatively wraps 45 may comprise clips, or loops 85 may comprise preformed bevels which rest over the golf cart structure 90. Reference number 91 shows the mechanism 75 disassembled while 92 shows the mechanism 75 partially assembled with the wrap 45 laced through the loops 85. The present embodiment reduces the materials needed to secure a golf bag to a golf cart by eliminating the need for a strap.

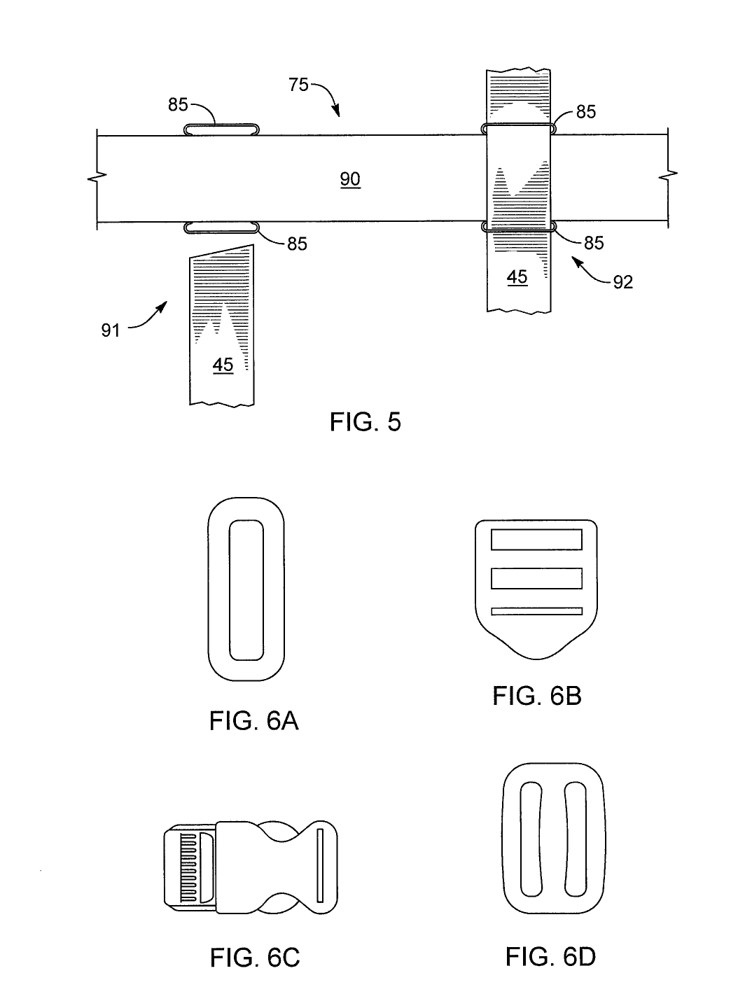

FIGS. 6A-6D illustrates a variety of securing and tightening mechanisms available. In utilizing these mechanisms, a strap is secured to the coupling member and then looped over a golf cart structure such as a cross bar. The strap is then looped back through the securing and tightening mechanisms illustrated in FIGS. 6A-6D and the tension on the strap is adjusted until the bag will remain sufficiently securing during transport.

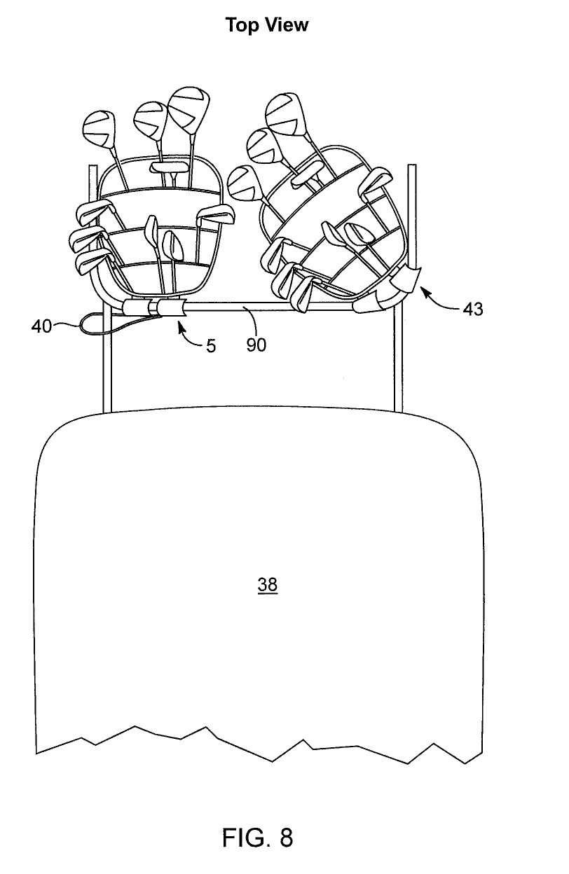

FIGS. 7 and 8 illustrate the coupling member 5 coupled to a golf cart structure 38, with optional toggle 40 looped around a golf cart cross-bar structure. Any of the embodiments disclosed herein may be utilized as shown in FIGS. 7 and 8. The golf bag 35 is placed on and secured to cart 38 using strap 5. The toggle 40 further secures the bag 35 to the cart 38. Furthermore, the indicia 43 is prominently displayed on the front of strap 5 so as to display the desired indicia. FIG. 8 illustrates the multiple straps being secured to coupling member and straps of various widths to provide the desired security between the bag/cart coupling. In addition, the increased width provides more space to prominently feature advertising space.

FIG. 8 further illustrates an alternative securing mechanisms in practice. A selective securing device 5 is illustrated with securing loop 40. As illustrated, a single strap or multiple straps can be used to couple the bag to the golf cart. Similarly securing mechanism 43 may be used as shown with wraps 45 wrapped around golf cart member 90.

A method of using exemplary embodiment 75 comprises: securing leg stand couplers 60 to golf bag leg stands, placing golf bag on a golf cart, lacing a strap 45 through loops 85 provided on the leg stand couplers 60 and securing the leg stand couplers 60 to the cart member 90. The leg stand coupler loops 85 may be selectively oriented to permit couple the leg stand couplers 60 to any desirable golf cart structure in any orientation.

Although specific embodiments and applications of the invention have been described in this specification, there is no intention that the invention be limited these exemplary embodiments and applications or to the manner in which the exemplary embodiments and applications operate or are described herein.

What is claimed is:

1. An apparatus which secures a golf bag to a golf cart comprising:
a first member releaseably coupleable to a golf bag;
a second member comprising a strap wherein the strap is releaseably coupleable to a member of a golf cart and wherein the strap is secured to the first member in an orthogonal direction to the first member to maintain the relative position of the first member with respect to the second;
and the second member in relative forming a second loop the loops being fixed contiguously together.

2. The apparatus of claim 1 wherein the first member comprises a strap.

3. The apparatus of claim 1 wherein the first member comprises a member which is formed from a rigid material and which is configured to selectively and releaseably receive a golf bag leg.

4. The apparatus of claim 3 wherein the first member further comprises a screw nut which can be selectively tightened.

5. The apparatus of claim 1 wherein the first member comprises a plurality of straps.

6. The apparatus of claim 1 wherein the first member comprises a toggle.

7. The apparatus of claim 1 wherein the second member further comprises a plurality of straps.

8. The apparatus of claim 1 wherein the second member further comprises a toggle.

9. The apparatus of claim 1 further comprising an advertising patch formed on first or second member.

10. The apparatus of claim 1 further comprising a slip resistant surface secured to the second member.

11. The apparatus of claim 1 further comprising an surface upon which can be placed an advertisement.

12. The apparatus of claim 11 wherein the advertising surface is selectively removable.

13. The apparatus of claim 11 wherein the surface is a clear cover behind which can be placed a logo.

14. A method of securing a golf club bag to a golf cart to prevent the golf club bag from rotating comprising:
obtaining a first member configured to releaseably couple to a golf bag leg stand;
obtaining a second member and coupling the second member to the first member so the first and second members lie in orthogonal planes;
releaseably coupling the first member to a golf club bag;
releaseably coupling the second member to a member of a golf cart to prevent the golf club bag from rotating during transportation.

15. The method of claim 14 further comprising releaseably coupling advertising indicia to the second member.

16. The method of claim 14 further comprising coupling slip resistant material to the second member.
